(19) United States
(12) Patent Application Publication
(10) Pub. No.: US 2009/0242584 A1
(43) Pub. Date: Oct. 1, 2009

(54) BEVERAGE DISPENSING APPARATUS AND METHOD

(75) Inventor: Tim Palmer, Cambs (GB)

Correspondence Address: K&L Gates LLP, P.O. Box 1135, CHICAGO, IL, 60690, US

(73) Assignee: NESTEC S.A., Vevey (CH)

(21) Appl. No.: 12/411,862

(22) Filed: Mar. 26, 2009

(30) Foreign Application Priority Data
Apr. 1, 2008 (EP) 08153916.5

(51) Int. Cl. B67D 1/10; B67D 1/12; B67D 5/63; F04B 17/04

(52) U.S. Cl. 222/1; 222/333; 415/1; 417/417

(57) ABSTRACT

A beverage dispensing apparatus is disclosed, comprising a solenoid pump coupled between a fluid inlet and a fluid outlet for pumping the fluid from said inlet to said outlet, said pump comprising a spring-loaded linear pumping member axially displaceable between a spring-loaded position and a spring-released end position and a controller for the solenoid pump, said controller being arranged to energize the pumping member into an intermediate position between the spring-released end position and the spring-loaded position. Consequently, the solenoid pump has improved noise characteristics and can be used to control the flow rate of the fluid whilst still being energized in substantially every cycle of an alternating current.

### BACKGROUND

The present invention relates to a beverage dispensing apparatus comprising a solenoid pump coupled between a fluid inlet and a fluid outlet for pumping the fluid from said inlet to said outlet, said pump comprising a spring-loaded linear pumping member axially displaceable between a spring-loaded stop position and a spring-released position, and a controller for the solenoid pump.

The present invention further relates to a method for controlling a solenoid pump in such an apparatus.

Beverage dispensing apparatuses are commonplace in both domestic and commercial environments. Such apparatuses are popular because they can dispense beverages on-demand, such as hot drinks, e.g. coffee or tea, in case of the apparatus comprising a heating stage, or chilled drinks, e.g. soft drinks or water, in case of the apparatus comprising a refrigeration stage. Such apparatuses are well-known in the art. An example of such an apparatus can for instance be found in US patent application No. 2007/181004.

Solenoid pumps are commonly used in such apparatuses because of their low cost and reliability. However, the use of a solenoid pump in a beverage dispensing apparatus is not without problems. For instance, the solenoid pump can be very noisy, which may be distracting and/or displeasing to the user of the beverage dispensing apparatus. Such noise pollution is caused by the fact that the axially displaceable, spring-loaded pumping member of the solenoid pump, e.g. a piston, impacts upon its end position in the de-energized position of the member, i.e. the position into which the displaceable pumping member is forced by the released spring.

There have been several efforts to reduce the noise produced by solenoid pumps. For instance, U.S. Pat. No. 5,073,095 and prior art citations therein disclose an electromagnetic pump, in which the end position comprises an annular washer to cushion the impact of the piston, thus reducing the noise produced by the electromagnetic pump. An alternative arrangement for reducing the noise produced by the pump is disclosed in French patent application FR 2,847,708 A1, in which the control circuitry of the solenoid pumps is arranged to create a counter force to the force generated by the releasing spring from the current generated in the solenoid by the spring-released displacement of the piston, thus leading to a reduction in speed and/or a change (i.e. limitation) of the spring-released end position of the piston. However, this has the disadvantage that an additional inductor is required in the control circuitry to recycle the current used to bring the piston in its spring-loaded position.

U.S. Pat. No. 4,308,475 discloses a solenoid-actuated fluid pump having a reciprocable armature operable by a magnetic circuit and with a structure in the flux path at the upper and lower air gaps to substantially change the reluctance across the air gaps as the armature moves beyond a predetermined location. The armature has slots for passage of fluid there through and which have a C-shaped cross-section to minimize the air gaps.

EP 0 288 216 A1 discloses a pump operated using an electromagnetically vibrated armature with a central through-conduit and passive valves. The armature has a narrower extension to operate the valves, through which the conduit also passes. In order to avoid fluid building up between the armature and its guide, and impeding the movements of the armature, at least one of these is irregularly shaped, to provide firstly longitudinal through paths for such fluid to be quickly scavenged and removed, and secondly, cooperating guiding surfaces which are bypassed by the fluid, and not subject to fluid build-up between them.

WO 02/061780 A1 discloses a servo control using ferromagnetic core material and electrical windings based upon monitoring of winding currents and voltages and inference of magnetic flux, a force indication and magnetic gap.

### SUMMARY

The present invention seeks to provide a relatively quiet beverage dispensing apparatus according to the opening paragraph.

The present invention further seeks to provide a method for controlling a beverage dispensing apparatus according to the opening paragraph such that the beverage dispensing apparatus can be operated relatively quietly.

According to an aspect of the present invention, there is provided a beverage dispensing apparatus comprising a solenoid pump coupled between a fluid inlet and a fluid outlet for pumping the fluid from said inlet to said outlet, said pump comprising a spring-loaded linear pumping member axially displaceable between a spring-loaded position and a spring-released end position and a controller for the solenoid pump, said controller being responsive to a current waveform, said apparatus being characterized by the controller being arranged to generate a control signal for controlling the pumping member from said current waveform by excluding a part of the current waveform from the control signal such that the pumping member is energized into an intermediate position between the spring-released end position and the spring-loaded position.

The present invention is based on the realization that the impact of the pumping member on the spring released end position of the pump can be reduced by reducing the axial displacement of the pumping member from the spring released end position. This limits the amount of energy stored in the spring, and thus limits the impact of the pumping member on the end position, i.e. the stop, of the solenoid pump.

Preferably, the controller is responsive to an alternating current, and arranged to provide the solenoid pump with the control signal substantially in each period of the alternating current.

In an embodiment, the control signal is a phase-angled sinusoidal signal, with the amount of energy being defined by the phase-angle. This has the advantage that the control signal can be easily derived from the alternating current by selecting the rectified part of the relevant half-period of the alternating current as defined by the phase angle.

Energizing the solenoid pump in substantially every period of the alternating current has advantages over solenoid pumps that are controlled by means of a so-called burst fire control mechanism, in which the pump is energized in a subset of a predefined number of alternating current periods, e.g. 3 of 10 periods or 5 of 10 periods.

It has been found that a burst fire control mechanism causes substantial fluctuations in the fluid flow through the beverage dispensing apparatus, which can have a detrimental impact on the accuracy of the measurement of the fluid flow. This is especially true when the fluid flow meter of the beverage dispensing apparatus comprises a paddle wheel, because the paddle wheel is incapable of coping with the periodic burst-type increases in the fluid flow, which cause the paddle wheel to spin, thereby reducing the accuracy of the fluid flow measurement by the fluid flow meter. Such fluctuations are avoided by energizing the solenoid pump in substantially every period of the alternating current, which causes the fluid flow rate to become substantially constant over said periods.

It can be important to obtain an accurate reading of the fluid flow rate, for instance when the fluid flow rate is used to ensure that a high quality beverage is dispensed. For example, in case of the beverage dispensing apparatus comprising a holder for receiving a beverage brewing product such as coffee or tea e.g. in a pad, a capsule or another suitable type of beverage product package, the control of the fluid flow rate may be of significant importance to ensuring the correct strength of the beverage brewed by the apparatus. To this end, the measured flow rate may be used as a control input for the controller, wherein the controller is arranged to set the amount of energy of the control signal in response to a fluid flow rate indication signal, e.g. by adjusting the control signal based on a discrepancy between the fluid flow rate indication signal and a required fluid flow rate, which may be user-defined. For instance, a user may require a strongly brewed beverage, which may be achieved by reducing the flow rate of the fluid through a beverage brewing product.

According to a further aspect of the present invention, there is provided a method of controlling a solenoid pump for pumping a fluid from a fluid inlet to a fluid outlet of a beverage dispensing apparatus, said pump comprising a spring-loaded linear pumping member axially displaceable between a spring-loaded stop position and a spring-released position, the method being characterized by comprising generating a control signal for controlling the pumping member from a current waveform by excluding a part of the current waveform from the control signal; and providing the control signal to the pumping member, thereby energizing the pumping member into an intermediate position between the spring-released end position and the spring-loaded position.

A solenoid pump operated in accordance with the method of the present invention benefits from reduced noise levels during operation, as previously explained. In addition, if the pump is energized in substantially every control cycle, e.g. a phase half-cycle of an alternating current, an additional advantage of providing a substantially constant fluid flow rate is achieved, as previously explained.

Additional features and advantages are described herein, and will be apparent from the following Detailed Description and the figures.

### BRIEF DESCRIPTION OF THE FIGURES

Embodiments of the invention are described in more detail and by way of non-limiting examples with reference to the accompanying drawings, wherein

FIG. 1 schematically depicts a beverage dispensing apparatus in accordance with an embodiment of the present invention;

FIG. 2 schematically depicts an aspect of the beverage dispensing apparatus in accordance with an embodiment of the present invention in greater detail;

FIG. 3 schematically depicts an aspect of an alternative beverage dispensing apparatus in accordance with an embodiment of the present invention;

FIG. 4 schematically depicts a control signal for a solenoid pump in accordance with an embodiment of the present invention; and

FIG. 5 schematically depicts a control signal for a solenoid pump in accordance with an alternative embodiment of the present invention.

### DETAILED DESCRIPTION

It should be understood that the Figures are merely schematic and are not drawn to scale. It should also be understood that the same reference numerals are used throughout the Figures to indicate the same or similar parts.

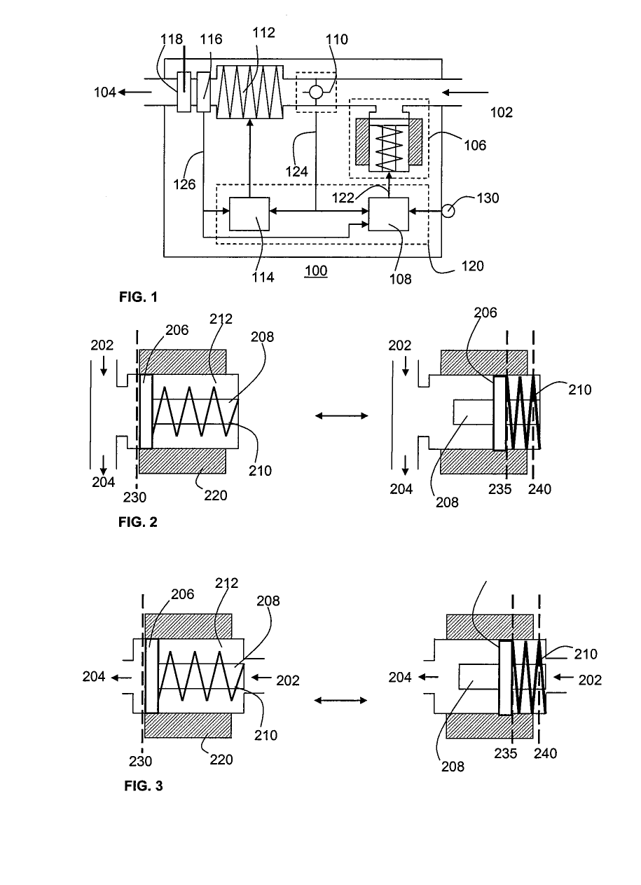

FIG. 1 schematically depicts a beverage dispensing apparatus 100 in accordance with an embodiment of the present invention. The beverage dispensing apparatus 100 comprises a fluid inlet 102, e.g. an inlet for receiving a liquid such as water or a soft drink, and a fluid outlet 104 for dispensing a beverage to a user of the beverage dispensing apparatus 100. A solenoid pump 106 is arranged between the fluid inlet 102 and the fluid outlet 104 for pumping a fluid from the inlet to the outlet. The solenoid pump 106 is controlled by a controller 108, which will be described in more detail later.

In addition, the beverage dispensing apparatus 100 may have any suitable configuration, since the embodiment of the beverage dispensing apparatus 100 is not critical to the present invention. For instance, the conduit between the fluid inlet 102 and the fluid outlet 104 may further comprise a flow meter 110, which may be a paddle wheel-based flow meter, a temperature adjustment stage 112, which may be a fluid heating stage and/or a fluid refrigeration stage, a temperature sensor 116 and a holder 118 for receiving a beverage brewing product, e.g. coffee or tea, which may be placed in the holder 118 in the form of loose material, e.g. coffee granules or tea leaves, or packaged in a pad, capsule or other suitable package. Other embodiments are equally suitable.

The controller 108 is arranged to provide the solenoid pump 106 with a control signal 122. The control signal 122 is defined by the controller 108 to ensure that the fluid presented at the fluid outlet 104 has the required properties, such as flow rate and/or temperature. For instance, control of the flow rate may be important to ensure that the fluid flow rate is relatively constant, and at a rate that is experienced as pleasant by the user of the beverage dispensing apparatus 100. Control of the flow rate may also be important to ensure that, in case the beverage dispensing apparatus 100 comprises a beverage brewing product holder 116, the strength of the beverage presented at the fluid outlet 104 is in accordance with user requirements.

Control of the flow rate may also be important to ensure that a temperature adjustment stage 112 is capable of appropriately adjusting the temperature of the fluid. In case of an excessive flow rate, the temperature adjustment stage 112 may have insufficient capacity to sufficiently adjust this temperature, leading to a perceived loss of quality by the user of the beverage dispensing apparatus 100.

To this end, the controller 108 may be responsive to signals indicative of the read-out data from the fluid flow meter 110 and/or the temperature sensor 116, i.e. signals 124 and 126. The controller 108 may be arranged to compare such a feedback signal, e.g. feedback signal 124 from the fluid flow meter 110 indicating an actual fluid flow rate, with a predefined fluid flow rate, and be arranged to adjust the control signal 122 in response to a determined discrepancy between the actual fluid flow rate and the predefined fluid flow rate. The predefined fluid flow rate may correspond with a user-selected fluid output requirement, and may be stored in any suitable data storage medium, e.g. a SRAM, a ROM, a look-up table and so on. The beverage dispensing apparatus 100 may comprise a user interface 130, e.g. one or more buttons, for allowing a user to define such a fluid output requirement, e.g. the strength or temperature of a beverage to be dispensed.

In an embodiment, the controller may be arranged to monitor the supply current, e.g. to detect fluctuations in a power supply current or voltage, e.g. flicker or other types of variations, and adjust the control signal 122 accordingly to maintain a required fluid flow rate. Such fluctuations in the power supply may for instance occur when the temperature adjusting stage 112, e.g. heating elements in a heating stage, switches on or off.

In a further embodiment, the apparatus 100 comprises a temperature sensor (not shown) for sensing a temperature of the solenoid of the solenoid pump 106, and for compensating for a change in the resistance of the windings of the solenoid caused by a change in the solenoid temperature to ensure that a required flow rate is maintained.

It should be appreciated that the above examples of possible control mechanisms of the solenoid pump 106 are non-limiting examples only. Other suitable control principles involving the controller 108 will be apparent to the skilled person, and it should be understood that combinations of the suitable control mechanisms including the disclosed control mechanisms are also feasible. The controller 108 may be a discrete component of the beverage dispensing apparatus 100 realized in hardware. Alternatively, the controller 108 may be a part of a signal processor 120, which may be further arranged to implement other controllers, e.g. a controller 114 for controlling the temperature adjustment stage 112, and for processing feedback signals such as the feedback signal 124 from the fluid flow meter 110 and the feedback signal 126 from the temperature sensor 116. The controller 108 may be implemented in software on such a signal processor 120.

The inventive control principle of the solenoid pump 106 in the beverage dispensing apparatus 100 is explained in more detail in FIG. 2. In FIG. 2, the solenoid pump 106 comprises a fluid inlet 202 and a fluid outlet 204, which may comprise valves (not shown). The solenoid pump 106 further comprises an axially displaceable pumping member 206, e.g. a piston or a diaphragm, which is axially displaceable over an axis 208 under control of the solenoid 220. To this end, the pumping member 206 may comprise a magnetic material. A spring 210 is mounted behind the pumping member 206 such that the spring 210 is compressed when the pumping member 206 is moved towards the inlet 202 under control of the solenoid 220.

In FIGS. 1 and 2, the solenoid pump 106 is configured to have a T-junction arrangement between the inlet 202, the outlet 204 and the chamber 212 of the solenoid pump 106. However, it is emphasized this arrangement is shown by way of non-limiting example only, and that other embodiments of the solenoid pump 106 are equally feasible, such as an alternative arrangement in which the solenoid pump 106 of the beverage dispensing apparatus of FIG. 1 is replaced with a solenoid pump as shown in FIG. 3. In the solenoid pump 106 shown in FIG. 3, the chamber 212 is placed between the inlet 202 and the outlet 204. Such a solenoid pump is also well-known; see for instance U.S. Pat. No. 6,942,470.

The pumping member 206 can be axially moved between an end position 230, in which the spring 210 has released its tension, and a spring-loaded position 240 under control of the solenoid 220, in which the spring 210 is fully compressed. The end position 230 may comprise a stop, e.g. a shock absorbing member. The displacement of the pumping member 206 from end position 230 towards the spring loaded position 240 causes a fluid to be sucked into the chamber 212 of the solenoid pump 106 through inlet 202, whereas the release of the tension in the spring 210 causes the pumping member 206 to be displaced towards the end position 230, thereby pumping the fluid collected in the chamber 212 through the outlet 204.

As has been explained previously, the release of the tension in the spring 210 during the pumping action of the solenoid pump 106 accelerates the pumping member 206 towards the end position 230, with the impact of the pumping member 210 at the end position 230 creating a substantial amount of noise. To this end, in accordance with the present invention, the controller 108 is arranged to control the solenoid 220 such that the pumping member is not fully retracted into the chamber 212, but displaced from the end position 230 to an intermediate position 235 in between the end position 230 and the spring-loaded position 240. In other words, the amount of energy stored in the form of tension (compression) of the spring 210 is less than the maximum amount of energy that can be stored in the spring 210. Consequently, when the spring 210 is released, the force on the pumping member 206 is reduced compared to the force generated by a fully loaded spring 210, thus reducing the impact of the pumping member 206 on the end position 230 and the noise generated by this impact.

A further advantage of partially retracting the pumping member 206 into the chamber 212 is that the fluid flow rate generated by the solenoid pump 106 may be adjusted whilst still activating the solenoid pump 106 in each phase cycle of an alternating current powering the beverage dispensing apparatus 100 and/or the controller 108. This may be achieved by dynamically adjusting the intermediate position 235, e.g. moving it towards the end position 230 or towards the spring-loaded position 240. This is not possible in solenoid pumps in which the amount of force exerted by the spring 210 on the pumping member 206 cannot be adjusted. In such pumps, the flow rate must be adjusted by altering the number of phase cycles during which the pump is activated, e.g. burst fire mode controlled solenoid pumps. However, as previously explained, such pumps exhibit substantial variations in the fluid flow rate over a period of time, which can cause problems when monitoring the flow rate with a paddle wheel-based flow meter, because such flow meters cannot respond correctly to the sudden changes in the fluid flow rate that are typical for burst fire mode controlled solenoid pumps. The activation of the solenoid pump 106 in substantially every phase cycle of the controller 108 ensures that the fluid flow rate through the conduit of the beverage dispensing apparatus 100 exhibits less pronounced variations over a period of time, thus allowing the fluid flow rate to be accurately monitored with a paddle wheel-based flow meter 110.

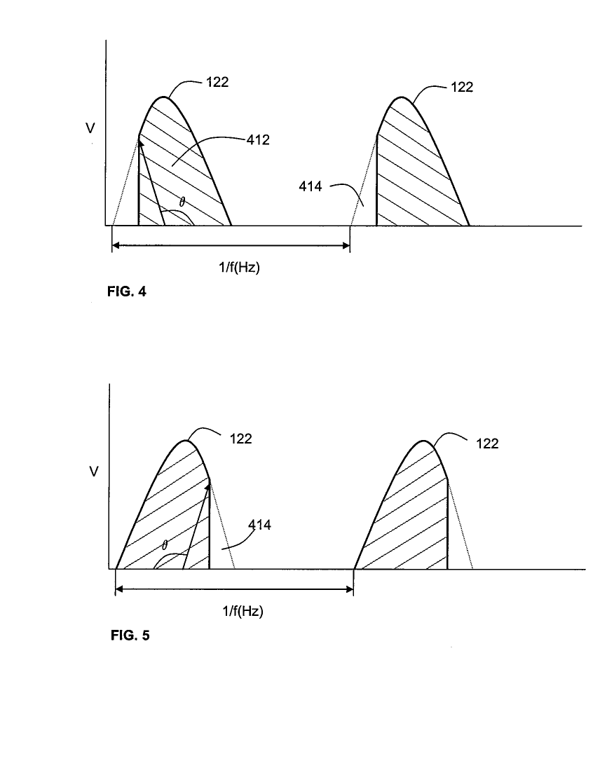

FIG. 4 shows a control signal 122 produced by the controller 108 in accordance with an embodiment of the present invention. The control signal 122 in FIG. 3 is derived from a rectified half period of a current alternating at a frequency f, e.g. 50 Hz or 60 Hz. The amplitude of the control signal 122 is the drive voltage V of the solenoid pump 106. The controller 108 is arranged to forward a phase-angled part of this half-phase to the solenoid 220 of the solenoid pump 106. The phase angle θ effectively defines the area 412 under the control signal 122. The size of the area 412 is correlated to the amount of energy to be stored in the spring 210. Variation of the phase angle θ thus varies the amount of energy to be stored in the spring 210 of the solenoid pump 106, or, in other words, the location of the intermediate position 235 in the chamber 212. The area 414 indicates the part of the half period of the alternating current that is excluded from the control signal 122. The periods of the control signal 122 are separated in time by a distance 1/f, i.e. occur in each phase cycle of the alternating current.

The phase angle θ may be dynamically adjusted by the controller 108, e.g. in response to a feedback signal 124 from the flow meter 110, indicating a discrepancy between an intended fluid flow rate and an actual fluid flow rate, or in response to a change in user requirements. Other embodiments for dynamically adjusting this phase angle will be apparent to the skilled person.

It will be appreciated that the shape of the control signal 122 in FIG. 4 is shown by way of non-limiting example only. Other shapes are equally feasible. For instance, as shown in FIG. 5, the area 414 excluded from the control signal 122 may be located at the end of the half phase of the alternating current instead of at its beginning. Alternatively, the control signal 122 does not have to be derived from an alternating current, and does not need to have a truncated sinusoidal shape. Other wave forms, e.g. square waves, are equally feasible.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A beverage dispensing apparatus, comprising:
a solenoid pump located between a fluid inlet and a fluid outlet for pumping fluid from the inlet to the outlet, the pump comprising a spring-loaded linear pumping member axially displaceable between a spring-loaded position and a spring-released end position; and
a controller for the solenoid pump, the controller being responsive to a current waveform and generating a control signal for controlling the pumping member from the current waveform by excluding a part of the current waveform from the control signal such that the pumping member is energized into an intermediate position between the spring-released end position and the spring-loaded position.

2. An apparatus according to claim 1, wherein the controller is responsive to an alternating current, and provides the solenoid pump with the control signal substantially in each period of the alternating current.

3. An apparatus according to claim 2, wherein the controller sets an amount of energy of the control signal in response to a fluid flow rate indication signal.

4. An apparatus according to claim 3, wherein the control signal is a phase-angled sinusoidal signal, with the amount of energy being defined by the phase-angle.

5. An apparatus according to claim 4, wherein the phase-angled sinusoidal signal is a phase-angled part of a rectified half-period of the alternating current.

6. An apparatus according to claim 3, wherein the apparatus further comprises a flow meter for producing the fluid flow rate indication signal, the controller adjusting the control signal based on a discrepancy between the fluid flow rate indication signal and a required fluid flow rate.

7. An apparatus according to claim 6, wherein the flow meter comprises a paddle wheel.

8. An apparatus according to claim 6, wherein the required flow-rate is user-defined.

9. An apparatus according to claim 1, further comprising a fluid temperature adjustment stage between the fluid inlet and the fluid outlet.

10. An apparatus according to claim 9, wherein the fluid temperature adjustment stage comprises a heating stage, the apparatus comprising a holder between the heating stage and the fluid outlet for receiving a beverage brewing product.

11. An apparatus according to claim 1, comprising a signal processor, wherein the controller is implemented in software on the signal processor.

12. A method of controlling a solenoid pump for pumping a fluid from a fluid inlet to a fluid outlet of a beverage dispensing apparatus, the pump comprising a spring-loaded linear pumping member axially displaceable between a spring-loaded position and a spring-released end position, comprising:
generating a control signal for controlling the pumping member from a current waveform by excluding a part of the current waveform from the control signal; and
providing the control signal to the pumping member, thereby energizing the pumping member into an intermediate position between the spring-released end position and the spring-loaded position.

13. A method according to claim 12, wherein the providing step comprises providing the solenoid pump with the control signal substantially in each period of an alternating current.

14. A method according to claim 13, wherein the step of providing the control signal comprises providing a phase-angled sinusoidal signal, with the amount of energy being defined by the phase-angle.

15. A method according to claim 13, further comprising adjusting the control signal based on a discrepancy between a fluid flow rate indication signal and a required fluid flow rate.

16. A beverage dispensing apparatus, comprising:
a fluid inlet, a fluid outlet and a solenoid pump for pumping fluid from the inlet to the outlet, the pump comprising a spring-loaded linear pumping member displaceable between a spring-loaded position and a spring-released end position; and
a controller for the solenoid pump, the controller being responsive to a current waveform and generating a control signal for controlling the pumping member from the current waveform by excluding a part of the current waveform from the control signal causing the pumping member to move into an intermediate position between the spring-released end position and the spring-loaded position.
